(19) United States
(12) Patent Application Publication
(10) Pub. No.: US 2023/0024506 A1
(43) Pub. Date: Jan. 26, 2023

(54) VEHICLE BODY REAR PORTION STRUCTURE

(71) Applicant: HONDA MOTOR CO., LTD., TOKYO (JP)

(72) Inventors: Takashi NITTA, Tokyo (JP); Hirotaka HAYAKAWA, Tokyo (JP); Toshihiro YAMAGUCHI, Tokyo (JP)

(21) Appl. No.: 17/859,050

(22) Filed: Jul. 7, 2022

(30) Foreign Application Priority Data
Jul. 15, 2021 (JP) 2021-117082

(51) Int. Cl. B62D 43/10

(52) U.S. Cl. CPC B62D 43/10

(57) ABSTRACT

A vehicle body rear portion structure includes a vehicle body floor, and the vehicle body floor includes a tire storage area that is hollowed downward in a recess shape. The vehicle body floor includes a front extension wall and a raised part. The front extension wall extends to a vehicle body forward side from an upper end part of a rise wall on a front side of the tire storage area. The raised part stands upward from a front part of the front extension wall and extends substantially along a vehicle width direction. A plurality of reinforcement beads that extend along a vehicle body forward/rearward direction and have a front end portion which extends to a vicinity of a lower end of the raised part are formed on the front extension wall to be spaced apart from each other in the vehicle width direction.

### CROSS-REFERENCE TO RELATED APPLICATION

Priority is claimed on Japanese Patent Application No. 2021-117082, filed on Jul. 15, 2021, the contents of which are incorporated herein by reference.

### BACKGROUND

### Field of the Invention

The present invention relates to a vehicle body rear portion structure in which a tire storage area is provided on a rear part of a vehicle body floor.

### Background

As a vehicle body rear portion structure, such a structure is known in which a tire storage area is provided on a rear part of a vehicle body floor. The tire storage area is formed to be hollowed downward in a recess shape on the rear part of the vehicle body floor, and a spare tire is stored in the tire storage area. In this type of vehicle body rear portion structure, when an impact load is input from a vehicle rearward direction, the spare tire in the tire storage area may move forward and interfere with a member on an occupant room side.

As a countermeasure, a vehicle body rear portion structure has been proposed in which a separate brace is attached to a front portion in the tire storage area, and a front part of the spare faces an inclination surface of the brace that is inclined upward toward a forward side (for example, refer to Japanese Unexamined Patent Application, First Publication No. 2006-213252).

In the vehicle body rear portion structure, at an input of an impact load from the vehicle rearward direction, the front part of the spare tire is guided by the inclination surface of the brace and stands upward, and thereby, the movement of the spare tire toward the occupant room direction (a direction to a battery installation part) is prevented.

### SUMMARY

However, in the vehicle body rear portion structure described above, the separate brace is attached to the front portion of the tire storage area in order to prevent the spare tire from moving in the occupant room direction at (the time of) input of an impact load from the vehicle rearward direction. Therefore, the number of components of the vehicle rear part increases, which is likely to cause an increase in the vehicle weight and a rise of production costs.

An aspect of the present invention provides a vehicle body rear portion structure capable of preventing a spare tire from moving in an occupant room direction at input of an impact load from a vehicle rearward direction while preventing an increase in the number of components.

A vehicle body rear portion structure according to an aspect of the present invention includes a vehicle body floor on which a tire storage area that is hollowed downward in a recess shape is provided, wherein the vehicle body floor includes a front extension wall that extends to a vehicle body forward side from an upper end part of a rise wall on a front side of the tire storage area and a raised part that stands upward from a front part of the front extension wall and extends substantially along a vehicle width direction, and a plurality of reinforcement beads that extend along a vehicle body forward/rearward direction and have a front end portion which extends to a vicinity of a lower end of the raised part are formed on the front extension wall to be spaced apart from each other in the vehicle width direction.

According to the above configuration, when an impact load is output from a vehicle rearward direction, deformation of the front extension wall in a vehicle body forward/rearward direction is prevented by the plurality of reinforcement beads. When an excessive load is input from a vehicle body rearward side to a rear part of the front extension wall, a rear side of the front extension wall is lifted upward using the lower end of the raised part as a deformation start point. Therefore, when the spare tire stored in the tire storage area comes into contact with the rise wall (a rear end part of the front extension wall) on the front side of the tire storage area with an excessive force at input of the impact load from the vehicle rearward direction, the rear part of the front extension wall is lifted upward, and the front part of the spare tire follows the lift of the rear part of the front extension wall and jumps upward. As a result, the movement of the spare tire in the occupant room direction is prevented.

The reinforcement bead arranged inward in the vehicle width direction may be formed such that a length in the vehicle body forward/rearward direction is longer than that of the reinforcement bead arranged outward in the vehicle width direction.

In this case, when the front end portion of the spare tire comes into contact with the rear part of the front extension wall with an excessive force at input of an impact load from the vehicle rearward direction, the front end portion (a front part in a middle region in the vehicle width direction) of the spare tire follows a rising behavior of the reinforcement bead having a long length and jumps upward with a large stroke. Accordingly, when the present configuration is employed, it is possible to efficiently prevent the movement of the spare tire in the occupant room direction.

The reinforcement bead that is located at an outermost position in the vehicle width direction may be arranged further inward in the vehicle width direction than an outer end part in the vehicle width direction of the tire storage area.

In this case, the reinforcement beads are arranged in front of the region in which the spare tire is arranged in the tire storage area. Therefore, at input of an impact load from the vehicle rearward direction, it is possible to reliably receive the load of the spare tire that moves forward by the reinforcement bead, and it is possible to efficiently lift the rear part of the front extension wall upward through the reinforcement bead.

A stiffener that extends along the vehicle body forward/rearward direction and reinforces the vehicle body floor may be attached to the raised part of the vehicle body floor and a lower surface on a front side of the raised part, and the front end portion of at least part of the reinforcement beads may extend to a vicinity of a rear end part of the stiffener.

In this case, since the stiffener is arranged on the front side of at least part of the reinforcement beads of the vehicle body floor, it is possible to efficiently prevent the deformation of a front side part of the reinforcement bead of the vehicle body floor by the stiffener at input of the impact load from the vehicle rearward direction. Further, since the raised part of the vehicle body floor is reinforced by the stiffener that extends along the vehicle body forward/rearward direction, the rear part of the front extension wall can be reliably displaced upward using the vicinity of the lower end of the raised part as a bend start point when the impact load is input from the vehicle rearward direction.

The stiffener may be joined to the raised part of the vehicle body floor and the lower surface on the front side of the raised part and constitute a closed cross-section that butts a rear wall of the raised part, and the reinforcement bead having the front end portion that extends to the vicinity of the rear end part of the stiffener may be arranged so as to overlap substantially linearly in a forward/rearward direction with the corresponding stiffener on a front side.

In this case, at input of the impact load from the vehicle rearward direction, when a load is input to the reinforcement bead of the front extension wall, the load is supported by the closed cross-section formed of the vehicle body floor and the corresponding stiffener that is arranged substantially linearly on the front side of the reinforcement bead. Accordingly, when the present configuration is employed, the load input to the reinforcement bead can be efficiently received by the closed cross-section formed of the vehicle body floor and the stiffener, and the rear part of the front extension wall can be further reliably displaced upward.

A curved surface having a middle region in the vehicle width direction that is curved in a recess shape to a vehicle body forward side may be provided on a rear portion of the raised part, one of the stiffeners and one of the reinforcement beads may be arranged at front and rear sides of an outer end part in the vehicle width direction of the curved surface, rest of the reinforcement beads may be arranged at a rear part in an inner region in the vehicle width direction of the curved surface, and a front end portion of the rest of the reinforcement beads may be lapped in the vehicle body forward/rearward direction with the rear end part of the stiffener.

In this case, stiffness properties of the front extension wall and the raised part are efficiently enhanced by the plurality of reinforcement beads and the stiffeners, and the length in the vehicle body forward/rearward direction of the reinforcement bead arranged at the rear part in the inner region in the vehicle width direction of the curved surface is set to be long. Accordingly, when the present configuration is employed, the front part of the spare tire that moves forward at input of the impact load from the vehicle rearward direction can be efficiently lifted upward by the reinforcement bead having a long length.

The stiffener may include a forward/rearward extension part that extends substantially horizontally at a height at which the forward/rearward extension part is lapped in an upward/downward direction with the reinforcement bead arranged on a rearward side.

In this case, since the forward/rearward extension part of the stiffener extends substantially horizontally at the height at which the forward/rearward extension part is lapped in the upward/downward direction with the reinforcement bead, at input of the impact load from the vehicle rearward direction, the load input to the reinforcement bead can be efficiently received by the forward/rearward extension part of the stiffener on a front side. Accordingly, when the present configuration is employed, the stiffness property on the front side of the tire storage area of the vehicle body floor can be further enhanced, and the front part of the spare tire can be further reliably jumped at input of the impact load from the vehicle rearward direction.

The rise wall on the front side of the tire storage area and a rear surface of the raised part may be inclined to a vehicle body forward side toward an upward direction, and a tire fixation part in the tire storage area may be arranged at a vehicle body rearward side further than the rise wall.

In this case, when the impact load is input from the vehicle rearward direction, and the spare tire in the tire storage area is displaced forward together with the tire fixation part, the front part of the spare tire hits the rise wall on the front side of the tire storage area and advances upward along the inclination of the rear surface of the raised part and the rise wall. Thereby, the front part of the spare tire smoothly stands upward, and the movement of the spare tire to the occupant room direction is prevented.

A bottom wall of the tire storage area may be inclined downward toward a vehicle body rearward direction.

In this case, since the spare tire becomes an attitude inclined forward and upward along the bottom wall of the tire storage area, the front part of the spare tire is smoothly lifted upward when the tire storage area deforms at input of an impact load from the vehicle rearward direction. Accordingly, when the present configuration is employed, at input of the impact load from the vehicle rearward direction, it is possible to cause the front part of the spare tire to further smoothly stand upward, and it is possible to further prevent the movement of the spare tire to the occupant room direction.

The reinforcement bead may have a height and a width in the vehicle width direction that are increased toward a vehicle body rearward side.

In this case, the stiffness property of the reinforcement bead is enhanced toward the rear side, and the deformation of the front extension wall when the impact load is input from the vehicle rearward direction is effectively prevented. Further, since the cross-section of the reinforcement bead becomes smaller toward the front side, the front extension wall is easily deformed using the vicinity of the lower end of the raised part as a bend start point at input of the impact load from the vehicle rearward direction. That is, it becomes difficult to inhibit the deformation using the lower end of the raised part of the front extension wall as the bend start point by the reinforcement bead. Therefore, at input of the impact load from the vehicle rearward direction, the rear part of the front extension wall is reliably lifted upward, and it becomes easy to cause the front part of the spare tire to stand upward.

A load input block that receives a vehicle traction load or a jack-up load may be provided on a lower surface of a rear end part of the vehicle body floor, and the load input block may include a front extension part that extends forward further than a tire fixation portion in the tire storage area.

In this case, when an impact load is input to the load input block from the vehicle rearward direction, a moment having a rotation center at the lower surface of the rear end part of the vehicle body floor acts on the load input block. Thereby, the front end side of the front extension part of the load input block is lifted upward, and the front end side of the spare tire in the tire storage area is lifted upward. As a result, the front part of the spare tire smoothly stands along with the function of the reinforcement bead of the front extension wall of the vehicle body floor, and the movement of the spare tire to the occupant room direction is further prevented.

In the vehicle body rear portion structure according to the aspect of the present invention, a plurality of reinforcement beads are formed on the front extension wall of the vehicle body floor to be spaced apart from each other in the vehicle width direction, each reinforcement bead extends along the vehicle body forward/rearward direction, and the front end portion of the reinforcement bead extends to the vicinity of the lower end of the raised part of the vehicle body floor. Therefore, when the spare tire stored in a tire pan comes into contact with the rise wall on the front side of the tire storage area at input of the impact load from the vehicle rearward direction, the rear part of the front extension wall is lifted upward, and the front part of the spare tire follows the lift of the rear part of the front extension wall and jumps upward. Accordingly, when the vehicle body rear portion structure according to the aspect of the present invention is employed, it is possible to prevent the spare tire from moving in the occupant room direction at input of the impact load from the vehicle rearward direction while preventing an increase in the number of components.

### BRIEF DESCRIPTION OF THE DRAWINGS

FIG. 1 is a bottom view of a rear part of a vehicle according to an embodiment.

FIG. 2 is a cross-sectional view along a II-II line of FIG. 1.

FIG. 3 is a perspective view of the rear part of the vehicle according to the embodiment when seen from an upper side.

FIG. 4 is an enlarged view of a IV part of FIG. 2.

FIG. 5 is a partial cross-sectional perspective view of a floor reinforcement bead according to the embodiment.

FIG. 6 is a perspective view of the rear part of the vehicle according to the embodiment.

FIG. 7A is a cross-sectional view showing a deformation behavior of the rear part of the vehicle according to the embodiment.

FIG. 7B is a cross-sectional view showing the deformation behavior of the rear part of the vehicle according to the embodiment.

FIG. 7C is a cross-sectional view showing the deformation behavior of the rear part of the vehicle according to the embodiment.

FIG. 8 is a longitudinal cross-sectional view of a rear part of a vehicle according to another embodiment.

### DESCRIPTION OF EMBODIMENTS

Hereinafter, embodiments of the present invention will be described with reference to the drawings. An arrow FR that indicates a forward direction of a vehicle, an arrow UP that indicates an upward direction of the vehicle, and an arrow LH that indicates a leftward direction of the vehicle are shown at an appropriate position of the drawing.

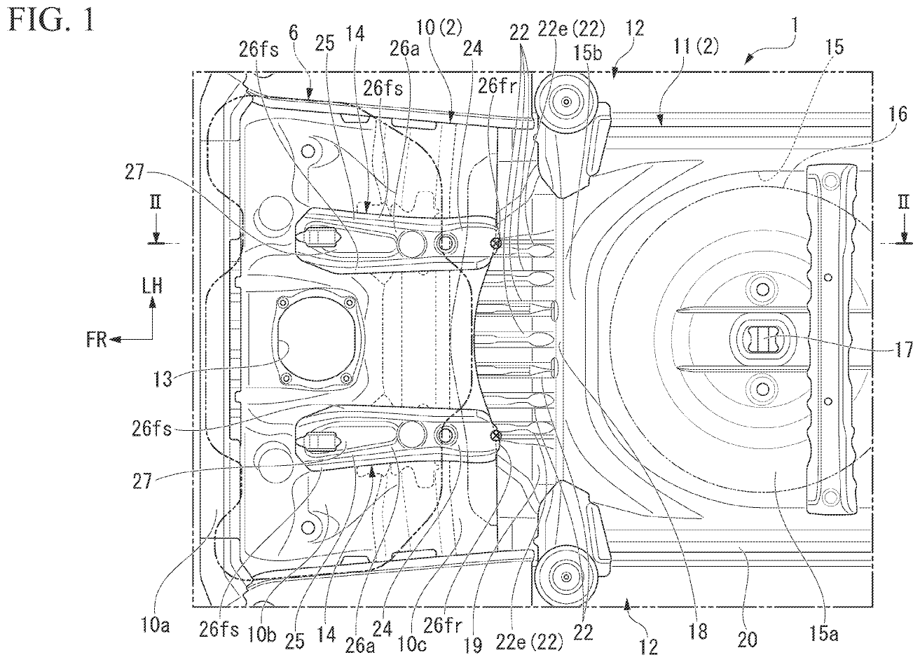

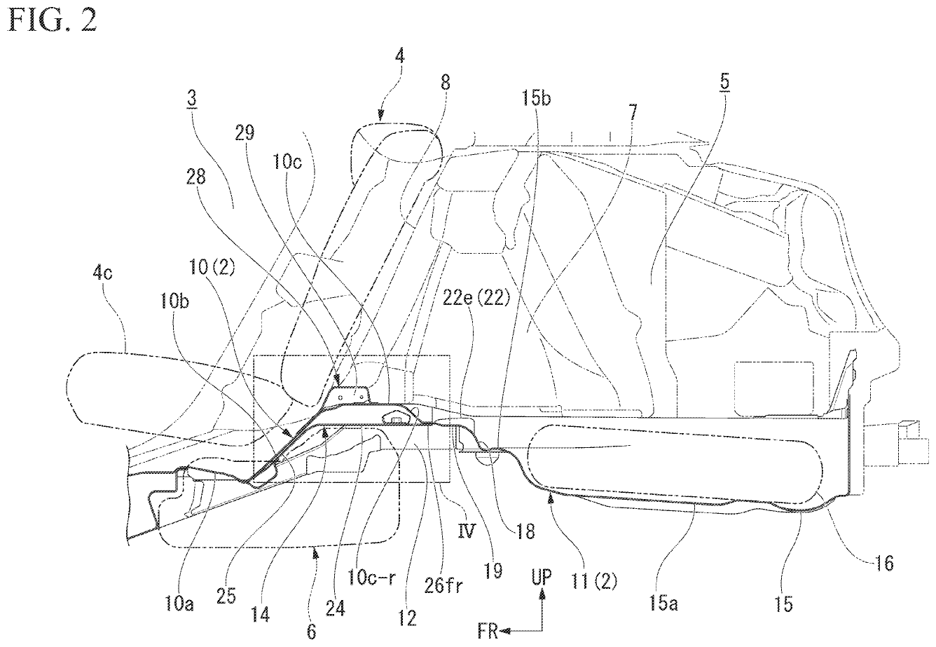

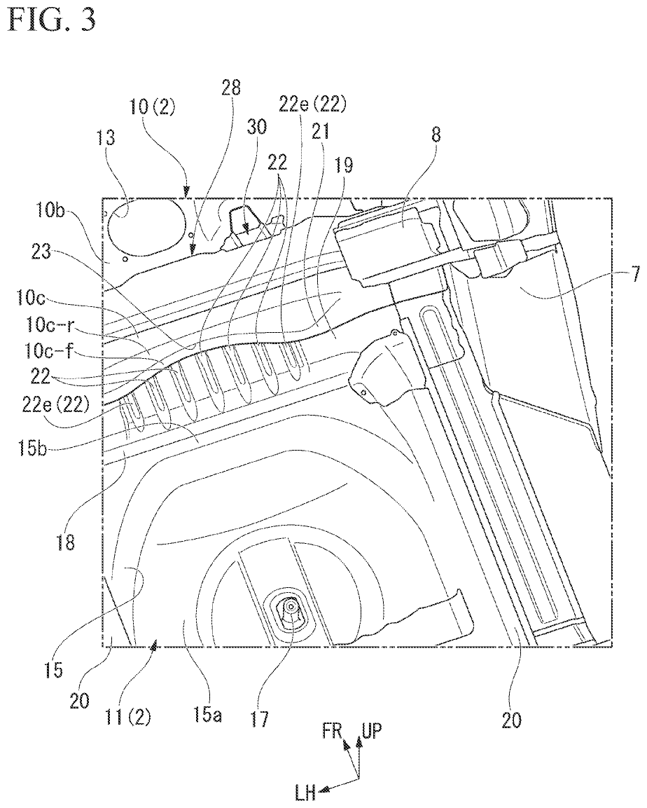

FIG. 1 is a bottom view of a rear part of a vehicle 1 according to the present embodiment. FIG. 2 is a cross-sectional view along a II-II line of FIG. 1. Further, FIG. 3 is a perspective view of a vehicle body floor 2 portion of the rear part of the vehicle 1 when seen from an upper side.

The vehicle body floor 2 includes a rear floor panel 10 arranged below an occupant room 3 and a tire pan 11 arranged below a load room 5 behind the occupant room 3. A rear seat 4 (occupant seat) is arranged above the rear floor panel 10. The rear floor panel 10 extends from a front part of the tire pan 11 to a vehicle body forward side. A rear side frame 12 that extends substantially along a vehicle body forward/rearward direction is arranged on both right and left sides of the rear floor panel 10 and the tire pan 11. The rear floor panel 10 and the tire pan 11 are provided on the right and left rear side frames 12.

Reference numeral 7 in FIG. 2 and FIG. 3 indicates a rear wheel house that covers a vehicle inside of a rear wheel (not shown), and reference numeral 8 indicates a reinforcement member that extends in an upward/downward direction along a vehicle inside surface of the rear wheel house 7. The reinforcement member 8 is joined to the vehicle inside surface of the rear wheel house 7 and forms a closed cross-section that extends in a vehicle upward/downward direction together with the rear wheel house 7. A lower end part of the reinforcement member 8 is joined to a corresponding rear side frame 12 on right and left sides.

As shown in FIG. 2, the rear floor panel 10 includes a lower part 10a positioned below a seat cushion 4c of a rear seat 4, an inclination part 10b that extends to be inclined rearward and obliquely upward from a rear end portion of the lower part 10a, and a raised part 10c formed continuously on an upper end region of the inclination part 10b. In the raised part 10c, a raised shape having a substantially trapezoidal shape extends throughout substantially the entire region in the vehicle width direction.

As shown in FIG. 3, a rear wall 10c-r that is inclined toward a lower rear part and a joint flange 10c-f that extends to bend to a vehicle rearward side from a lower end of the rear wall 10c-r are formed on a rear side of the raised part 10c. The joint flange 10c-f is joined to a front extension wall 19 described later of the tire pan 11. A curved surface 23 having a middle region in a vehicle width direction that is curved in a recess shape to a vehicle body forward side is provided on the rear wall 10c-r (a rear portion of the raised part 10c). The joint flange 10c-f positioned at a lower end of the curved surface 23 has a shape in a top view that is curved along the curved surface 23.

The raised part 10c stands upward from a front part of the front extension wall 19 described later of the tire pan 11 and extends substantially along the vehicle width direction.

A fuel tank 6 is arranged below a section that spans the lower part 10a, the inclination part 10b, and the raised part 10c. The fuel tank 6 is formed in an upper surface shape substantially along the shape of each lower surface of the lower part 10a, the inclination part 10b, and the raised part 10c. The fuel tank 6 extends to both right and left sides to sandwich a middle region in the vehicle width direction and is fixed to a lower part of the rear floor panel 10 by a fastener (not shown). Thereby, the fuel tank 6 is supported by a lower surface on a front side of a tire storage area 15 described later of the vehicle body floor 2.

A piping insertion hole 13 is formed in a middle region in the vehicle width direction of the inclination part 10b of the rear floor panel 10. A fuel pipe (piping, not shown) that extends upward from an upper part of the fuel tank 6 is inserted through the piping insertion hole 13. A pair of stiffeners 14 are arranged on a lower surface of the rear floor panel 10 at a further outward position in the vehicle width direction than the piping insertion hole 13. The stiffener 14 extends along the vehicle body forward/rearward direction and is joined to a lower surface of a region that ranges from the raised part 10c to a rear end portion of the lower part 10a. A front end portion of each stiffener 14 extends to a position that overlaps the piping insertion hole 13 in the vehicle body forward/rearward direction. Further, a rear end part of each stiffener 14 extends beyond a rear end position of the fuel tank 6 to a vehicle body rearward side. The stiffener 14 reinforces an upper region of the fuel tank 6 of the rear floor panel 10 (the vehicle body floor 2) at a forward position of the tire storage area 15 described later of the vehicle body floor 2. The detailed structure of the stiffener 14 will be described later in detail.

The tire pan 11 includes the tire storage area 15 having a substantially circular shape that is hollowed downward in a recess shape. A spare tire 16 is accommodated in the tire storage area 15. As shown in FIG. 2, a bottom wall 15a of the tire storage area 15 is inclined downward toward a vehicle body rearward side. A tire fixation portion 17 is arranged on substantially a middle of the bottom wall 15a of the tire storage area 15. A center part of the spare tire that is accommodated laterally in the tire storage area 15 is fixed to the tire fixation portion 17 by a fastener (not shown).

A step portion 15b that is higher by one step than the bottom wall 15a of the tire storage area 15 is provided on a front edge portion of the tire storage area 15 of the tire pan 11. A rise wall 18 that stands upward is provided on a front end portion of the step portion 15b. The front extension wall 19 that extends forward substantially horizontally is provided on an upper end part of the rise wall 18. The rise wall 18 extends substantially linearly in the vehicle width direction. However, the entire rise wall 18 does not stand vertically upward, and the rise wall 18 is inclined to a vehicle body forward side toward an upward direction. The rise wall 18 and the front extension wall 19 are continuous by a smooth circular arc.

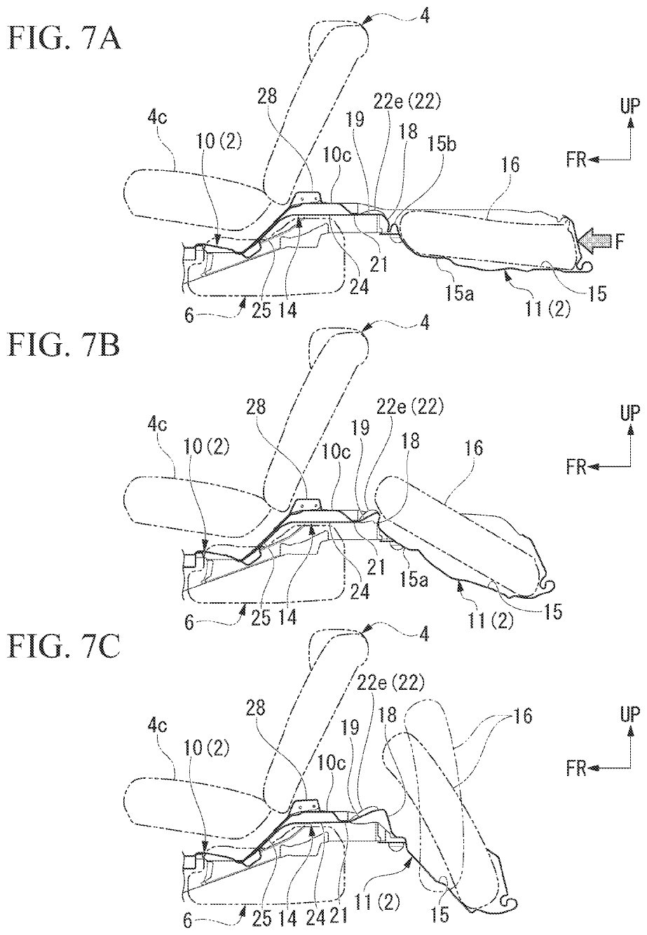

Here, the tire fixation portion 17 in the tire storage area 15 is arranged on a further rearward side than the rise wall 18. Therefore, when an impact load is input from a vehicle rearward side, and the spare tire 16 fixed to the tire fixation portion 17 is pushed upward and forward along the inclined bottom wall 15a, a front part of the spare tire 16 hits the vicinity of a corner portion on a rear end side of the step portion 15b, and the step portion 15b is bent and deformed such that the corner portion is lifted upward (refer to FIG. 7A). Then, when the spare tire 16 moves forward, the front part of the spare tire 16 comes into contact with part of the deformed bent step portion 15b and the inclined rise wall 18 and is guided to stand upward (refer to FIG. 7B and FIG. 7C).

Further, a side extension wall 20 that is higher by one step than the bottom wall 15a of the tire storage area 15 is provided on right and left side edge portions of the tire storage area 15. The right and left side extension walls 20 are joined to right and left opposite rear side frames 12, respectively.

A rear end part (the joint flange 10c-f of the raised part 10c) of the rear floor panel 10 is overlapped on an upper surface of a front end portion of the front extension wall 19 of the tire pan 11, and overlapped parts are joined together by welding or the like. Hereinafter, the parts that are joined together of the tire pan 11 and the rear floor panel 10 are referred to as a joint part 21.

A plurality of floor reinforcement beads 22 that extend along the vehicle body forward/rearward direction is formed on the front extension wall 19 of the tire pan 11. The plurality of floor reinforcement beads 22 are arranged in a middle region in the vehicle width direction of the front extension wall 19 to be spaced apart from each other at a substantially equal interval in the vehicle width direction. In each floor reinforcement bead 22, an expansion shape that expands upward extends in the vehicle body forward/rearward direction.

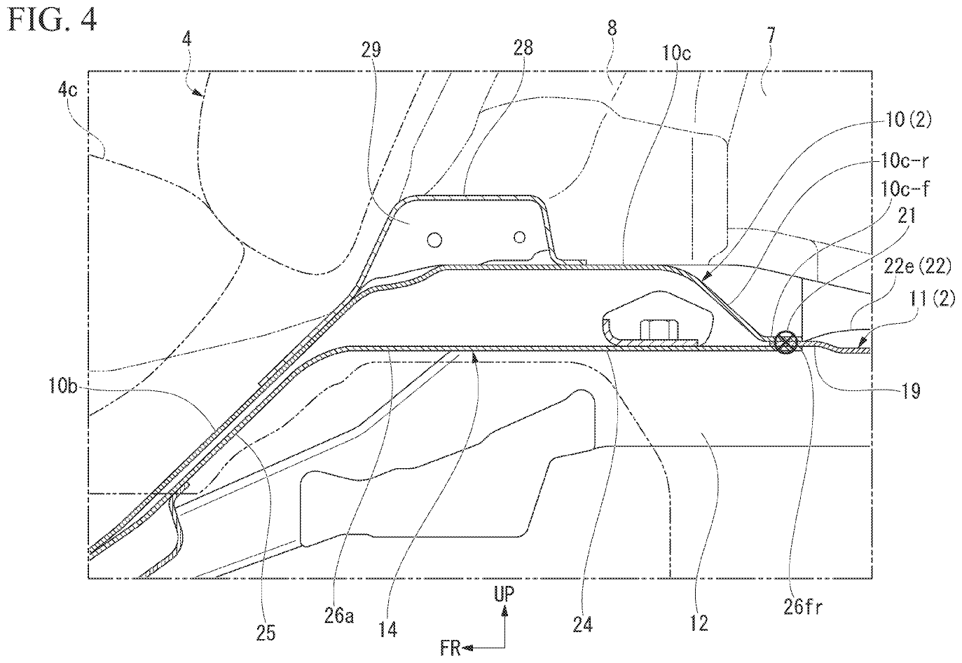

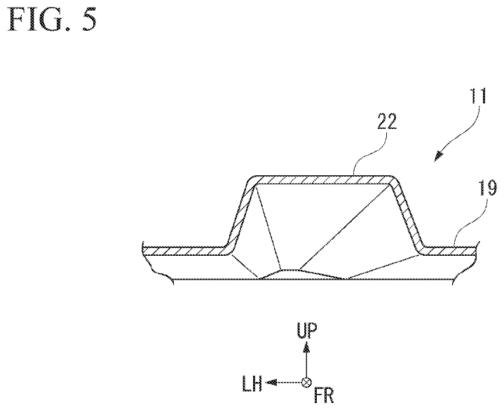

FIG. 4 is an enlarged view of a IV part of FIG. 2. FIG. 5 is a partial cross-sectional perspective view of the floor reinforcement bead 22. More specifically, FIG. 5 is a perspective view in which the vicinity of a rear part of the front extension wall 19 is cut along the vehicle width direction, and the front extension wall 19 is seen from the vehicle body rearward side with one floor reinforcement bead 22 as a center.

As shown in FIG. 4, FIG. 5 and the like, each floor reinforcement bead 22 is formed in a substantially trapezoidal shape in which a cross-section along the vehicle width direction spreads downward to widen toward the end. The cross-section of each floor reinforcement bead 22 is formed such that, except for the vicinity of the rear end part, the width and the height in the vehicle width direction are gradually decreased toward the vehicle body forward side (such that the width and the height in the vehicle width direction are gradually increased toward the vehicle body rearward side). A front end portion of each floor reinforcement bead 22 extends to the vicinity of a lower end (joint flange 10c-f) on the rear side of the raised part 10c of the rear floor panel 10.

A rear end part of each floor reinforcement bead 22 continues to a rear surface on an upper end side of the rise wall 18 while the width and the height in the vehicle width direction are gradually decreased toward the vehicle body rear side.

As shown in FIG. 3, since the middle region in the vehicle width direction of the rear lower end of the raised part 10c is a curved shape that is hollowed to the vehicle forward side, the extension length to the vehicle body forward side of each floor reinforcement bead 22 is longer as the floor reinforcement bead 22 is located further inward in the vehicle width direction. Accordingly, the floor reinforcement bead 22 arranged inward in the vehicle width direction is formed such that the length in the vehicle body forward/rearward direction is longer than that of the floor reinforcement bead 22 arranged outward in the vehicle width direction.

As shown in FIG. 1, right and left floor reinforcement beads 22e (floor reinforcement bead 22) that are located at an outermost position in the vehicle width direction are arranged so as to overlap (so as to align) substantially linearly in the vehicle body forward/rearward direction with the right and left stiffeners 14, respectively. The stiffener 14 is arranged on the vehicle body forward side, and the plurality of floor reinforcement beads 22e are arranged on the vehicle body rearward side such that the stiffener 14 and the plurality of floor reinforcement beads 22e interpose the rear wall 10c-r of the raised part 10c of the rear floor panel 10. More specifically, the right and left stiffeners 14 and the outermost floor reinforcement beads 22e in the vehicle width direction are arranged at front and rear positions of an outer end part in the vehicle width direction of the curved surface 23 of the rear wall 10c-r. The rest of the floor reinforcement beads 22 are arranged at a rear part in an inner region in the vehicle width direction of the curved surface 23 of the rear wall 10c-r. A front end portion of the rest of the floor reinforcement beads 22 is located at a further vehicle forward position than the rear end parts of the right and left stiffeners 14. That is, the front end portion of the rest of the floor reinforcement beads 22 is lapped in the vehicle body forward/rearward direction with the rear end parts of the right and left stiffeners 14.

Further, the right and left floor reinforcement beads 22e that are located at the outermost position in the vehicle width direction are arranged at a position further inward in the vehicle width direction than right and left end parts in the vehicle width direction of the tire storage area 15. Accordingly, all of the floor reinforcement beads 22 on the front extension wall 19 are positioned on a movement track when the spare tire 16 in the tire storage area 15 moves forward.

Similar to the right and left floor reinforcement beads 22e that are located at the outermost position in the vehicle width direction, the right and left stiffeners 14 are arranged at a position further inward in the vehicle width direction than the right and left end parts in the vehicle width direction of the tire storage area 15. Therefore, the right and left stiffeners 14 are positioned on a movement track when the spare tire 16 moves forward.

As shown in FIG. 1 and FIG. 4, the stiffener 14 includes a forward/rearward extension part 24 that extends substantially horizontally along the vehicle body forward/rearward direction and an inclination part 25 that extends to be inclined downward from a front end portion of the forward/rearward extension part 24 toward the vehicle body forward side. In the forward/rearward extension part 24 and the inclination part 25, a cross-sectional shape along the vehicle width direction is a substantially hat shape. That is, in the forward/rearward extension part 24 and the inclination part 25, a side flange portion 26fs that protrudes outward in the vehicle width direction is provided on right and left edge portions of a recess shape part 26a that is hollowed downward. Further, a rear flange portion 26fr that extends from a bottom wall of the recess shape part 26a toward the vehicle body rearward side is provided on a rear end portion of the forward/rearward extension part 24.

In each stiffener 14, the forward/rearward extension part 24 is joined to a lower surface of the raised part 10c of the rear floor panel 10, and the inclination part 25 is joined to a lower surface of the inclination part 10b of the rear floor panel 10 and a rear end lower surface of the lower part 10a. The forward/rearward extension part 24 and the inclination part 25 are joined to the lower surface of the rear floor panel 10 at the side flange portion 26fs and the rear flange portion 26fr. Thereby, the stiffener 14 forms a closed cross-section that is continuous in the vehicle body forward/rearward direction with the rear floor panel 10. The closed cross-section bends along the forward/rearward extension part 24 and the inclination part 25 of the stiffener 14, and the rear end part butts the rear wall 10c-r of the raised part 10c.

Here, the floor reinforcement bead 22e that are located at the outermost position in the vehicle width direction extends to the vicinity of the rear end part of each of the right and left stiffeners 14 so as to interpose the rear wall 10c-r of the raised part 10c. Each floor reinforcement bead 22e having the front end portion that extends to the vicinity of the rear end part of the stiffener 14 is aligned so as to overlap substantially linearly in the forward/rearward direction with the stiffener 14 on the forward side. Further, the forward/rearward extension part 24 of each stiffener 14 extends substantially horizontally at a height at which at least part of the forward/rearward extension part 24 is overlapped in the upward/downward direction with the floor reinforcement bead 22 arranged on the rearward side.

Here, the front end portion of the tire pan 11 and the rear end part of the rear floor panel 10 are joined together at the joint part 21 as described above. As shown in FIG. 4, the rear flange portion 26fr of the rear end of each stiffener 14 is inserted in a space of the joint part 21 between the rear floor panel 10 and the tire pan 11 and, in that state, is welded and fixed with the tire pan 11 and the rear floor panel 10 in an overlapped three-layer state. That is, the rear end part of each stiffener 14 is joined to the joint part 21 of the tire pan 11 and the rear floor panel.

Further, as shown in FIG. 1, a stiffener reinforcement bead 27 that is hollowed upward is provided on a bottom wall of the recess shape part 26a of the inclination part 25 of each stiffener 14. The stiffener reinforcement bead 27 extends along the vehicle body forward/rearward direction (along the extension direction of the inclination part 25) and enhances the stiffness property of the inclination part 25 of the stiffener 14.

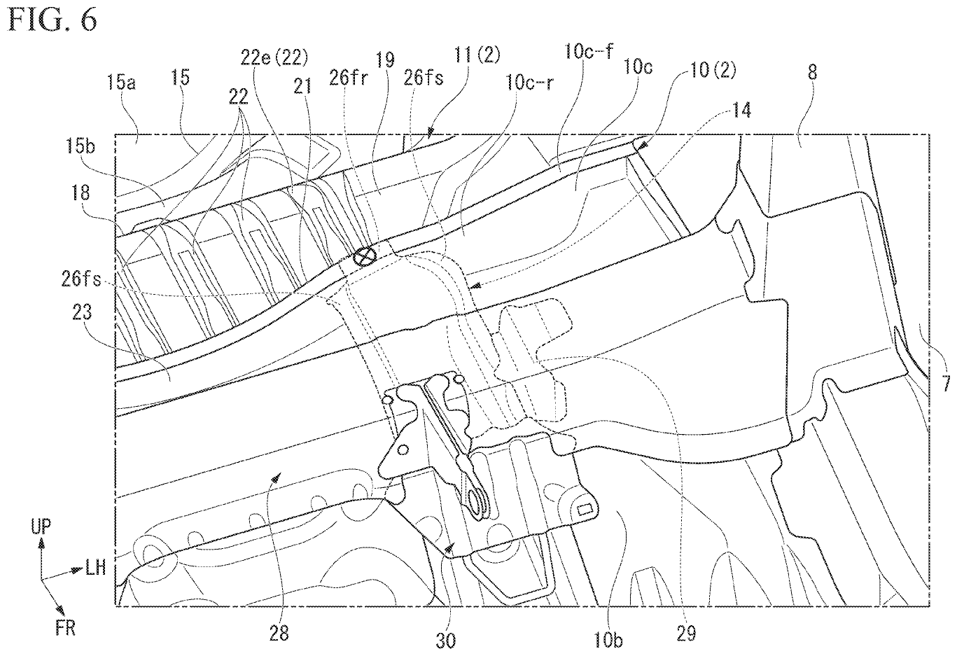

FIG. 6 is a perspective view of the rear part (vehicle body floor 2) of the vehicle 1 when seen from a forward upward side.

As shown in FIG. 2 to FIG. 4 and FIG. 6, a cross member 28 that extends along the vehicle width direction is joined to an upper surface of the raised part 10c (forward position of the tire storage area 15) of the rear floor panel 10. The cross member 28 is formed in a cross-sectional shape of a substantially hat shape, and front and rear flange parts are joined to an upper surface of the raised part 10c. Thereby, the cross-member 28 forms a closed cross-section along the vehicle width direction together with the raised part 10c (vehicle body floor 2). An outer end part in the vehicle width direction of the cross member 28 is joined to the reinforcement member 8 that extends upward along the rear wheel house 7.

As shown in FIG. 6, each of the right and left stiffeners 14 is joined to a lower surface of the rear floor panel 10 (vehicle body floor 2) at a position that intersects the cross member 28. A bulkhead member 29 (bulkhead) that reinforces, from the inside, a closed cross-section formed of the raised part 10c (vehicle body floor 2) and the cross member 28 is attached to the closed cross-section at a position that intersects the stiffener 14.

Further, as shown in FIG. 6, an anchor bracket 30 for supporting a seat belt anchor used for the rear seat 4 is attached to the cross member 28 at a vehicle body forward side of a position that intersects each stiffener 14.

### <Deformation Behavior of Vehicle Body Rear Part>

FIGS. 7A to 7C are schematic cross-sectional views showing the deformation behavior of the rear part of the vehicle 1 when an impact load is input from a vehicle rearward direction in order of FIG. 7A, FIG. 7B, and FIG. 7C.

Hereinafter, the deformation behavior of the vehicle body rear part at input of the impact load is described with reference to FIGS. 7A to 7C.

As shown in FIG. 7A, when a large impact load F is input from a rearward direction of the tire pan 11, the tire storage area 15 of the tire pan 11 is deformed and collapsed in the vehicle body forward/rearward direction, and the spare tire 16 in the tire storage area 15 is pushed forward. Thereby, the front part of the spare tire 16 comes into contact with the rear surface of the step portion 15b of a front edge of the tire storage area 15, and the step portion 15b is deformed and bent such that the corner portion on the rear side of the step portion 15b is lifted upward. Then, when the spare tire 16 is to move further forward, the front part of the spare tire 16 comes into contact with the collapsed deformed step portion 15b and the forward inclined rise wall 18, and the spare tire 16 is guided such that the front part of the spare tire 16 is gradually lifted along with the collapsed deformation of the tire storage area 15.

When the input of the impact load F further proceeds from this state, as shown in FIG. 7B, the front part of the spare tire 16 comes into contact with the vicinity of the rear end part of the front extension wall 19, and the impact load F is input through the spare tire 16 to the rear part of the front extension wall 19. At this time, since the middle region in the vehicle width direction of the front extension wall 19 is reinforced by the plurality of floor reinforcement beads 22, the front extension wall 19 is displaced such that the rear end side is lifted upward using the vicinity of the joint part 21 with the rear floor panel 10 on the front end side as a bend start point. As a result, the spare tire 16 is guided such that the front part is lifted further upward.

At this time, when a larger load is input through the spare tire 16 to the vicinity of the rear end part of the front extension wall 19, a deformation load is also input to the rear region of the rear floor panel 10. A pair of stiffeners 14 are arranged along the vehicle body forward/rearward direction in the rear region of the rear floor panel 10, and each stiffener 14 has a structure that includes the forward/rearward extension part 24 and the inclination part 25. Therefore, as shown in FIG. 7C, the rear end side of the forward/rearward extension part 24 is lifted, and the rear end part of the front extension wall 19 is lifted further upward such that a bend angle between the inclination part 25 and the forward/rearward extension part 24 of each stiffener 14 is enlarged. As a result, the spare tire 16 is guided such that the front part is lifted further upward and stands.

As described above, in the vehicle 1 of the present embodiment, at input of the impact load F from the vehicle rearward direction, the energy of the impact load is absorbed by the deformation of the vehicle rear part, and in that process, the spare tire 16 exhibits a behavior of standing upward. Then, the spare tire 16 stands upward, and thereby, the displacement to the fuel tank 6 or the rear seat 4 direction is prevented.

### <Effects of Embodiment>

In the vehicle body rear portion structure of the present embodiment, the plurality of floor reinforcement beads 22 are formed on the front extension wall 19 of the vehicle body floor 2 to be spaced apart from each other in the vehicle width direction, each floor reinforcement bead 22 extends along the vehicle body forward/rearward direction, and the front end portion of the floor reinforcement bead 22 extends to the vicinity of the lower end of the raised part 10c of the vehicle body floor 2. Therefore, when the spare tire 16 in the tire storage area 15 comes into contact with the rise wall 18 on the front side at input of the impact load from the vehicle rearward direction, the rear part of the front extension wall 19 is lifted upward, and the front part of the spare tire 16 follows the lift of the rear part of the front extension wall 19 and jumps upward. Accordingly, when the vehicle body rear portion structure of the present embodiment is employed, it is possible to prevent the spare tire 16 from moving in the occupant room 3 direction (the direction to the rear seat 4 (occupant seat)) at input of the impact load from the vehicle rearward direction while preventing an increase in the number of components.

In the vehicle body rear portion structure of the present embodiment, among the plurality of floor reinforcement beads 22, a floor reinforcement bead 22 arranged inward in the vehicle width direction has an extension length in the vehicle body forward/rearward direction which is longer than that of a floor reinforcement bead 22 arranged outward in the vehicle width direction. Therefore, when the front end portion of the spare tire 16 comes into contact with the rear part of the front extension wall 19 with a large force at input of an impact load from the vehicle rearward direction, the front part in the middle region in the vehicle width direction of the spare tire 16 follows a lifting behavior of the floor reinforcement bead 22 having a long extension length and jumps upward with a large stroke. Accordingly, when the vehicle body rear portion structure of the present embodiment is employed, it is possible to efficiently prevent the movement of the spare tire 16 in the occupant room 3 direction.

Further, in the vehicle body rear portion structure of the present embodiment, the floor reinforcement bead 22 that is located at the outermost position in the vehicle width direction is arranged further inward in the vehicle width direction than the outer end part in the vehicle width direction of the tire storage area 15. Therefore, all of the floor reinforcement beads 22 on the vehicle body floor 2 are arranged in front of the region in which the spare tire 16 is arranged in the tire storage area 15. Accordingly, when the vehicle body rear portion structure of the present embodiment is employed, at input of an impact load from the vehicle rearward direction, the load of the spare tire 16 that moves forward can be reliably received by the floor reinforcement bead 22, and the rear part of the front extension wall 19 can be efficiently lifted upward through the floor reinforcement bead 22.

Further, in the vehicle body rear portion structure of the present embodiment, the stiffener 14 that extends along the vehicle body forward/rearward direction is attached to the lower surface of the rear floor panel 10, and the front end portion of the floor reinforcement bead 22e extends to the vicinity of the rear end part of the stiffener 14. Therefore, it is possible to efficiently prevent the deformation of the front side part of the floor reinforcement bead 22e of the rear floor panel 10 by the stiffener 14 at input of the impact load from the vehicle rearward direction. Further, since the raised part 10c of the rear floor panel 10 is reinforced by the stiffener 14 that extends along the vehicle body forward/rearward direction, the rear part of the front extension wall 19 can be reliably displaced upward using the vicinity of the lower end of the raised part 10c as a bend start point when the impact load is input from the vehicle rearward direction. Accordingly, when the present configuration is employed, it is possible to further prevent the movement of the spare tire 16 in the occupant room 3 direction.

Further, in the vehicle body rear portion structure of the present embodiment, the stiffener 14 is joined to the lower surface of the rear floor panel 10 and constitutes a closed cross-section that butts the rear wall 10c-r of the raised part 10c of the rear floor panel 10, and the floor reinforcement bead 22e on the tire pan 11 side is arranged so as to overlap substantially linearly in the forward/rearward direction with the corresponding stiffener 14 on the front side. Therefore, at input of the impact load from the vehicle rearward direction, when a load is input to the floor reinforcement bead 22e of the front extension wall 19, the load is supported by the closed cross-section formed of the rear floor panel 10 and the corresponding stiffener 14 that is arranged substantially linearly on the front side of the floor reinforcement bead 22e. Accordingly, when the present configuration is employed, the load input to the floor reinforcement bead 22e can be efficiently received by the closed cross-section formed of the rear floor panel 10 and the stiffener 14, and the rear part of the front extension wall 19 can be further reliably displaced upward.

Further, in the vehicle body rear portion structure of the present embodiment, the stiffener 14 and the floor reinforcement bead 22e are arranged on the rear wall 10c-r of the raised part 10c of the rear floor panel 10 at the front and rear sides of the outer end part in the vehicle width direction of the curved surface 23, and the rest of the floor reinforcement beads 22 are arranged at the rear part in the inner region in the vehicle width direction of the curved surface 23. The front end portion of the rest of the floor reinforcement beads 22 is lapped in the vehicle body forward/rearward direction with the rear end part of the stiffener 24. Therefore, the stiffness properties of the front extension wall 19 on the tire pan 11 side and the raised part 10c on the rear floor panel 10 side can be efficiently enhanced by the plurality of floor reinforcement beads 22 and the stiffeners 14, and the extension length in the vehicle body forward/rearward direction of the floor reinforcement bead 22 arranged at the rear part in the inner region in the vehicle width direction of the curved surface 23 can be set to be long. Accordingly, when the present configuration is employed, the front part of the spare tire 16 that moves forward at input of the impact load from the vehicle rearward direction can be efficiently lifted upward by the floor reinforcement bead 22 having a long length.

Further, in the vehicle body rear portion structure of the present embodiment, each stiffener 14 includes the forward/rearward extension part 24 that extends substantially horizontally at a height at which the forward/rearward extension part 24 is lapped in the upward/downward direction with the floor reinforcement bead 22e arranged on the rearward side. Therefore, at input of the impact load from the vehicle rearward direction, the load that is input to the floor reinforcement bead 22e can be efficiently received by the forward/rearward extension part 24 of the stiffener 14 on the front side. Accordingly, when the present configuration is employed, the stiffness property on the front side of the tire storage area 15 of the vehicle body floor 2 can be further enhanced, and the front part of the spare tire 16 can be further reliably jumped at input of the impact load from the vehicle rearward direction.

Further, in the vehicle body rear portion structure of the present embodiment, the rise wall 18 on the front side of the tire storage area 15 and the rear surface of the raised part 10c is inclined to the vehicle body forward side toward the upward direction. Further, the tire fixation part 17 in the tire storage area 15 is arranged at the vehicle body rearward side further than the rise wall 18. Therefore, when the impact load is input from the vehicle rearward direction, and the spare tire 16 in the tire storage area 15 is displaced forward together with the tire fixation part 17, the front part of the spare tire 16 hits the rise wall 18 on the front side of the tire storage area 15 and advances upward along the inclination of the rear wall 10c-r of the raised part 10c and the rise wall 18. Accordingly, when the present configuration is employed, at input of the impact load from the vehicle rearward direction, it is possible to cause the front part of the spare tire 16 to smoothly stand upward, and it is possible to further reliably prevent the movement of the spare tire 16 to the occupant room 3 direction.

Further, in the vehicle body rear portion structure of the present embodiment, the bottom wall 15a of the tire storage area 15 is inclined downward toward the vehicle body rearward direction. Therefore, the spare tire 16 accommodated in the tire storage area 15 becomes an attitude inclined forward and upward along the bottom wall 15a of the tire storage area 15. Accordingly, when an impact load is input from the vehicle rearward direction, and the tire storage area 15 deforms, the front part of the spare tire 16 is smoothly lifted upward. Accordingly, when the present configuration is employed, at input of the impact load from the vehicle rearward direction, it is possible to cause the front part of the spare tire 16 to further smoothly stand upward, and it is possible to further prevent the movement of the spare tire 16 to the occupant room 3 direction.

Further, in the vehicle body rear portion structure of the present embodiment, the floor reinforcement bead 22 formed on the front extension wall 19 has a height and a width in the vehicle width direction that are gradually increased toward the vehicle body rearward side except for the rear end part. Therefore, the stiffness property of the floor reinforcement bead 22 is enhanced toward the rear side, and the deformation of the front extension wall 19 when the impact load is input from the vehicle rearward direction is effectively prevented. Further, in the case of the present embodiment, since the cross-section of the floor reinforcement bead 22 becomes smaller toward the front side, at input of the impact load from the vehicle rearward direction, it becomes difficult to inhibit the deformation using the vicinity of the lower end of the raised part 10c of the front extension wall 19 as the bend start point by the floor reinforcement bead 22. Therefore, the front extension wall 19 is easily deformed using the vicinity of the lower end of the raised part 10c as a bend start point. Accordingly, when the present configuration is employed, at input of the impact load from the vehicle rearward direction, the rear part of the front extension wall 19 is reliably lifted upward, and it becomes easy to cause the front part of the spare tire 16 to stand upward.

### Another Embodiment

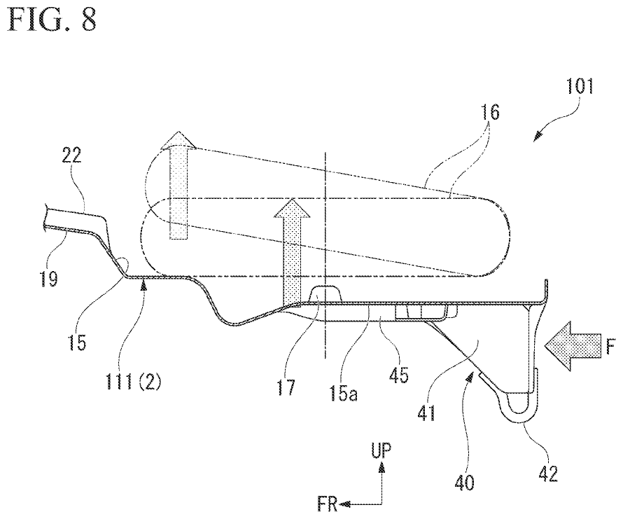

Hereinafter, another embodiment is described with reference to FIG. 8. In FIG. 8, portions which are common to those of the embodiment described above are denoted by the same reference numerals. Further, in the following description, explanation of portions overlapping with those of the embodiment described above is partially omitted.

FIG. 8 is a longitudinal cross-sectional view of a rear part of a vehicle 101 of the present embodiment. In FIG. 8, the rear part of the vehicle 101 is cut along a plane orthogonal to the vehicle width direction at a substantially middle position in the vehicle width direction.

In the vehicle body rear portion structure of the present embodiment, only the structure of the rear part of the vehicle body floor 2 is different from that of the embodiment described above, and other basic configurations are similar to those of the embodiment described above. The tire fixation portion 17 is provided at a substantially middle part of the bottom wall 15a of the tire storage area 15 of a tire pan 111. The spare tire 16 is stored in a substantially horizontal attitude in the tire storage area 15 and, in that state, is fixed to the tire fixation portion 17 by a fastener (not shown). A jack base 40 which is a load input block is attached to a lower surface (lower surface of a rear end part of the vehicle body floor 2) of a rear end part of the tire pan 111. The jack base 40 is arranged at a substantially middle position in the vehicle width direction of the tire pan 111.

The jack base 40 protrudes downward from the lower surface of the rear end part of the tire pan 111, and a front end portion of the jack base 40 extends continuously to the vehicle body forward direction beyond the tire fixation portion 17. The jack base 40 includes a base part 41, a front extension part 45, and a traction hook 42. All of the base part 41, the front extension part 45, and the traction hook 42 are constituted of a metal member.

The base part 41 is formed in a substantially trapezoidal shape in a side view in which upper and lower sides are substantially parallel to each other, and a front side is inclined rearward and downward. A rear side of the base part 41 in a side view extends substantially in the vertical direction. The base part 41 has a box structure having a substantially trapezoidal shape which has a sufficient width in the vehicle width direction. The base part 41 is joined to a lower surface and a rear surface of the tire pan 111.

In the front extension part 45, a cross-sectional shape having a hat shape protruding downward extends along a vehicle body forward/rearward direction, and a flange portion that projects in the vehicle width direction is joined to a lower surface of the tire pan 111. Further, a rear end portion of the front extension part 45 is integrally joined to a front end portion of the base part 41. A front end portion of the front extension part 45 extends to the vehicle body forward side beyond the tire fixation portion 17.

The traction hook 42 is formed of a rod material having a substantially J shape in a side view, and an upper end part of the traction hook 42 is joined to a lower end of the base part 41 by welding or the like. The traction hook 42 forms an annular part to which an end part of a traction rope is engaged at the time of traction by being joined to the lower end of the base part 41. Further, the traction hook 42 is joined to the base part 41 and thereby enhances the stiffness property of the lower end of the base part 41. Further, a lower end of the traction hook 42 also functions as a jack-up point against which the jack is pushed when jacking up the vehicle. Accordingly, the jack base 40 of the present embodiment receives a traction load when towing the vehicle, and receives a jack-up load when jacking up the vehicle.

In the vehicle 101 of the present embodiment, a height of a bottom surface of the tire pan 111 is set to be relatively high. Therefore, when the impact load F is input from the vehicle rearward direction, the load acts on a lower end side of the jack base 40 (the base part 41). Thereby, the impact load F acts on the jack base 40 as a moment in a clockwise direction in the drawing in which the upper end side of the base part 41 is a rotation center. As a result, a front extension part 45 of the jack base 40 is lifted upward and pushes the front part of the spare tire 16 in the tire storage area 15 upward.

When the input of the impact load F further continues in this way, the front part of the spare tire 16 comes into contact with the rear part of the floor reinforcement bead 22 while the rear part of the tire pan 111 collapses and deforms, and the behavior of the spare tire 16 is guided such that the front part stands. Accordingly, at input of the impact load from the vehicle rearward direction, the movement of the spare tire 16 in the occupant room direction is prevented similarly to the embodiment described above.

### <Effects of Another Embodiment>

In the vehicle body rear portion structure of the present embodiment, similarly to the embodiment described above, the plurality of floor reinforcement beads 22 are formed on the front extension wall 19 of the vehicle body floor 2 to be spaced apart from each other in the vehicle width direction, each floor reinforcement bead 22 extends along the vehicle body forward/rearward direction, and the front end portion of the floor reinforcement bead 22 extends to the vicinity of the lower end of the raised part of the vehicle body floor 2. Therefore, even when the vehicle body rear portion structure of the present embodiment is employed, it is possible to prevent the spare tire 16 from moving in the occupant room direction at input of the impact load from the vehicle rearward direction while preventing an increase in the number of components.

Further, in the vehicle body rear portion structure of the present embodiment, the front extension part 45 that extends forward further than the tire fixation portion 17 in the tire storage area 15 is provided on the jack base 40 (load input block) that is attached to the lower surface of the rear end part of the vehicle body floor 2. Therefore, at input of an impact load from the vehicle rearward direction, a moment that acts on the jack base 40 lifts the front part of the spare tire 16 upward through the front extension part 45. Accordingly, even in a vehicle in which the bottom wall 15a of the tire storage area 15 cannot be arranged to be inclined, it is possible to create a trigger of jumping of the front part of the spare tire 16 at input of the impact load from the vehicle rearward direction. Accordingly, when the vehicle body rear portion structure of the present embodiment is employed, the front part of the spare tire 16 smoothly stands along with the function of the floor reinforcement bead 22 of the front extension wall 19 of the vehicle body floor 2, and the movement of the spare tire 16 to the occupant room direction is prevented.

The present invention is not limited to the embodiment described above, and various design changes can be made without departing from the scope of the invention.

What is claimed is:

1. A vehicle body rear portion structure comprising:
a vehicle body floor on which a tire storage area that is hollowed downward in a recess shape is provided,
wherein the vehicle body floor includes
a front extension wall that extends to a vehicle body forward side from an upper end part of a rise wall on a front side of the tire storage area and
a raised part that stands upward from a front part of the front extension wall and extends substantially along a vehicle width direction, and
a plurality of reinforcement beads that extend along a vehicle body forward/rearward direction and have a front end portion which extends to a vicinity of a lower end of the raised part are formed on the front extension wall to be spaced apart from each other in the vehicle width direction.

2. The vehicle body rear portion structure according to claim 1,
wherein the reinforcement bead arranged inward in the vehicle width direction is formed such that a length in the vehicle body forward/rearward direction is longer than that of the reinforcement bead arranged outward in the vehicle width direction.

3. The vehicle body rear portion structure according to claim 1,
wherein the reinforcement bead that is located at an outermost position in the vehicle width direction is arranged further inward in the vehicle width direction than an outer end part in the vehicle width direction of the tire storage area.

4. The vehicle body rear portion structure according to claim 1,
wherein a stiffener that extends along the vehicle body forward/rearward direction and reinforces the vehicle body floor is attached to the raised part of the vehicle body floor and a lower surface on a front side of the raised part, and
the front end portion of at least part of the reinforcement beads extends to a vicinity of a rear end part of the stiffener.

5. The vehicle body rear portion structure according to claim 4,
wherein the stiffener is joined to the raised part of the vehicle body floor and the lower surface on the front side of the raised part and constitutes a closed cross-section that butts a rear wall of the raised part, and
the reinforcement bead having the front end portion that extends to the vicinity of the rear end part of the stiffener is arranged so as to overlap substantially linearly in a forward/rearward direction with the corresponding stiffener on a front side.

6. The vehicle body rear portion structure according to claim 5,
wherein a curved surface having a middle region in the vehicle width direction that is curved in a recess shape to a vehicle body forward side is provided on a rear portion of the raised part,
one of the stiffeners and one of the reinforcement beads are arranged at front and rear sides of an outer end part in the vehicle width direction of the curved surface,
rest of the reinforcement beads are arranged at a rear part in an inner region in the vehicle width direction of the curved surface, and
a front end portion of the rest of the reinforcement beads is lapped in the vehicle body forward/rearward direction with the rear end part of the stiffener.

7. The vehicle body rear portion structure according to claim 5,
wherein the stiffener includes a forward/rearward extension part that extends substantially horizontally at a height at which the forward/rearward extension part is lapped in an upward/downward direction with the reinforcement bead arranged on a rearward side.

8. The vehicle body rear portion structure according to claim 1,
wherein the rise wall on the front side of the tire storage area and a rear surface of the raised part are inclined to a vehicle body forward side toward an upward direction, and
a tire fixation part in the tire storage area is arranged at a vehicle body rearward side further than the rise wall.

9. The vehicle body rear portion structure according to claim 8,
wherein a bottom wall of the tire storage area is inclined downward toward a vehicle body rearward direction.

10. The vehicle body rear portion structure according to claim 1,
wherein the reinforcement bead has a height and a width in the vehicle width direction that are increased toward a vehicle body rearward side.

11. The vehicle body rear portion structure according to claim 1,
wherein a load input block that receives a vehicle traction load or a jack-up load is provided on a lower surface of a rear end part of the vehicle body floor, and
the load input block includes a front extension part that extends forward further than a tire fixation portion in the tire storage area.
